(19) United States
(12) Patent Application Publication
(10) Pub. No.: US 2020/0360803 A1
(43) Pub. Date: Nov. 19, 2020

(54) SPATIAL ENTERTAINMENT PLATFORM FOR INTERCONNECTED GAMING

(71) Applicant: Electric Playhouse, Inc., Albuquerque, NM (US)

(72) Inventors: John-Mark Collins, Albuquerque, NM (US); Brandon Garrett, Albuquerque, NM (US); Chris Steinmetz, Albuquerque, NM (US); Luke Balaoro, Albuquerque, NM (US); Ben Matthews, Albuquerque, NM (US); Eric Yakley, Albuquerque, NM (US)

(73) Assignee: Electric Playhouse, Inc., Albuquerque, NM (US)

(21) Appl. No.: 16/877,342

(22) Filed: May 18, 2020

Related U.S. Application Data
(60) Provisional application No. 62/849,675, filed on May 17, 2019.

(51) Int. Cl. A63F 13/27; A63F 13/847; G06F 3/01

(52) U.S. Cl. CPC A63F 13/27; A63F 13/847; A63F 2300/8082; G06F 3/017; G06F 3/011

(57) ABSTRACT

A spatial entertainment platform that be used for interconnected gaming in physical environments without requiring a user to wear goggles or other sensors. Optionally, users in different physical locations can interact in real-time in a single virtual environment. The system preferably uses one or more projectors and a plurality of sensors to track a user and map them to a virtual environment. The platform can be used not only for gaming but also for educational training, teambuilding, healthcare and for other applications.

### CROSS-REFERENCE TO RELATED APPLICATIONS

This application claims priority to and the benefit of the filing of U.S. Provisional Patent Application No. 62/849,675, entitled “Spatial Entertainment Platform for Interconnected Gaming”, filed on May 17, 2019, and the specification and proposed claim thereof are incorporated herein by reference.

### BACKGROUND F THE INVENTION

Embodiments of the present invention relate to a novel deployment of a large-scale sensor and display network of created media with relevant spatial motion tracking for real-time interactivity and gaming, which can include immersive gaming and large-scale interactive digital experiences, and which can optionally be provided across multiple rooms and/or multiple buildings. More particularly, embodiments of the present invention relate to the system of hardware devices (sensors, projectors, screens, media servers, computer devices, and peripheral) and software connecting and controlling all previously-mentioned hardware devices, and improve on existing entertainment systems, interactive digital experiences and collaborative gaming experiences by allowing people to simultaneously play games with large groups in unison, optionally across multiple spaces, with content reacting and changing based on user motion, which can optionally include all user motions. Embodiments of the present invention preferably achieve the foregoing without the use of headsets or other equipment that needs to be worn or carried, except for optional game mechanics, that can include balls, wands, guns, combinations thereof and the like.

The immersive gaming field, including virtual reality (“VR”) has been growing in an exponential fashion in the last decade—focused on bringing active and fully immersive experiences to individual users. However, there is a gap in sharable immersive and interactive experiences that do not require wearable hardware and headsets. Embodiments of the present invention enable social gaming without requiring users to hold or wear controllers, paddles or any additional hardware.

Group interactions within immersive and interactive spaces have been limited to handheld controllers (for example, standard video games and the WII® gaming platform, a registered mark of Nintendo of America, Inc., etc.), or limited range tracking (for example, the line of motion sensing input devices generally known as the KINECT® brand of devices, a registered mark of Microsoft Corp.), which is limited to 2-6 users on a single screen. There is thus a present need for a spatial entertainment platform that provides interconnected gaming, particularly for large-format shareable experiences with many simultaneous users.

### BRIEF SUMMARY OF EMBODIMENTS OF THE PRESENT INVENTION

An embodiment of the present invention relates to a real-time spatial positioning system that includes one or more sensors, one or more projectors, a sensor and depth server configured to acquire data from the one or more sensors, a spatial state server configured to triangulate a position of a physical object within a three-dimensional (“3D”) physical space, a game engine server configured to communicate with the spatial state server such that movement of the object causes effects on digital, non-physical objects or environments, and a media server configured to distribute content to the one or more projectors in the physical space, wherein the content includes a mapped projected representation of the object within the 3D physical space and wherein the content is viewable by a user without requiring the user to wear a headset. The content can be viewable by a user without requiring the user to wear or hold a handset. The one or more sensors can include one or more motion sensors, depth sensors, radio-frequency identification sensors, and/or a combination thereof. The 3D physical space can include a plurality of physically separate 3D physical spaces, which can optionally include a plurality of rooms. The sensor and depth server can be configured to aggregate a plurality of sensors across a plurality of physically separate 3D physical spaces.

In one embodiment, the content can include a 1:1 mapped, projected, representation of the object. The projected representation can be projected onto a physical surface within the 3D physical space. The physical object can include a person. The spatial state server can be configured to track gestures of the person. Optionally, at least some content can be projected onto at least half of all surfaces in the 3D physical space. The physical object can include a plurality of physical objects and at least one of the plurality of physical objects can include a person and another of the plurality of objects can include an inanimate physical object, which itself can include a ball and/or a wand. A single hardware device can operate at least two of: the depth server, the spatial state server, and the media server. The real-time spatial positioning system can be configured to perform a calibration routine whereby a plane of best fit is determined for at least one surface in the 3D physical space.

Embodiments of the present invention also relate to a method for providing a spatial positioning system that includes sensing a 3D location of an animal within an environment comprising at least a pair of walls and a floor, generating data representative of effects caused to non-physical objects based on movement of the animal, and projecting an image that is representative of the generated data onto at least the pair of walls in real time or near-real time. The animal can be a human. Projecting an image can include projecting an image that includes a representation of the animal at a size ratio of at least about 1:1

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIE OF THE DRAWINGS

The patent or application file contains at least one drawing executed in color. Copies of this patent or patent application publication with color drawing(s) will be provided by the Office upon request and payment of the necessary fee. The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a drawing that illustrates an overall diagram of how a spatial entertainment system can be laid out according to an embodiment of the present invention, including examples of pieces of hardware;

FIG. 2 is a drawing that illustrates basic motion tracking and location awareness as it pertains to a large spatial entertainment system and illustrates how an individual's interactions relate to the group's experience and overall gameplay within the context of a specific game;

FIG. 3 is a drawing that illustrates an overall software process for re-projecting depth and motion data according to an embodiment of the present invention;

FIG. 4 is an image that illustrates a projected edge (red line to the left of the figure), corresponding to an edge in the physical space, which in this figure is the intersection of the wall and the floor;

FIG. 5 is an image that illustrates a non-noisy checkerboard plane having a first color, which indicates that the projected plane is still some distance from the plane of best fit;

FIG. 6 is an image that illustrates the checkerboard pattern of FIG. 5, but wherein the checkerboard pattern is noisier than in FIG. 5 and wherein the light gray denotes zero, creating a flat plane of interaction data where the checkerboard has been blended away for something smoother;

FIG. 7 is an image that illustrates mapped data before it is scaled and transformed;

FIG. 8 illustrates the projected plane of media at exact scale;

FIG. 9 illustrates the initial skewed, inverted and full depth image before mapping;

FIG. 10 illustrates the mapped plane, before alignment;

FIG. 11 is a drawing which illustrates the re-projected and aligned plane of interaction, one-to-one with user alignment location; and

FIG. 12 is a drawing which illustrates the three axis depth re-mapping at 1:1 scale with each surface, wherein a sphere is used to illustrate a ball and wherein recognition planes are provided which are associated with each axis.

### DETAILED DESCRIPTION OF THE INVENTION

Embodiments of the present invention relate to a novel system for displaying media that allows for large-scale group interaction and exploration across multiple rooms and spaces without requiring the use of VR headsets or handsets. A sensor array network processes an individual's position within a physical space, and a spatial state server triangulates the individual's position and gestures within the virtual space of the 3D gaming engine or development platform at the location of interaction. Content that can optionally include spatial information, can be distributed to projectors and/or other display technology for an interactive, multi-room, multi-building, real-time experience that is one-to-one with the user. The experiences for larger groups can be tied together in a larger narrative (or game) that allows for different levels of gameplay and storytelling. Small groups can be located in one room and can be able to solve a local puzzle, while multiple groups in multiple zones, rooms, and/or buildings can work together on a larger interactive game.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, this application should be read with the understanding that such combinations are entirely within the scope of the invention.

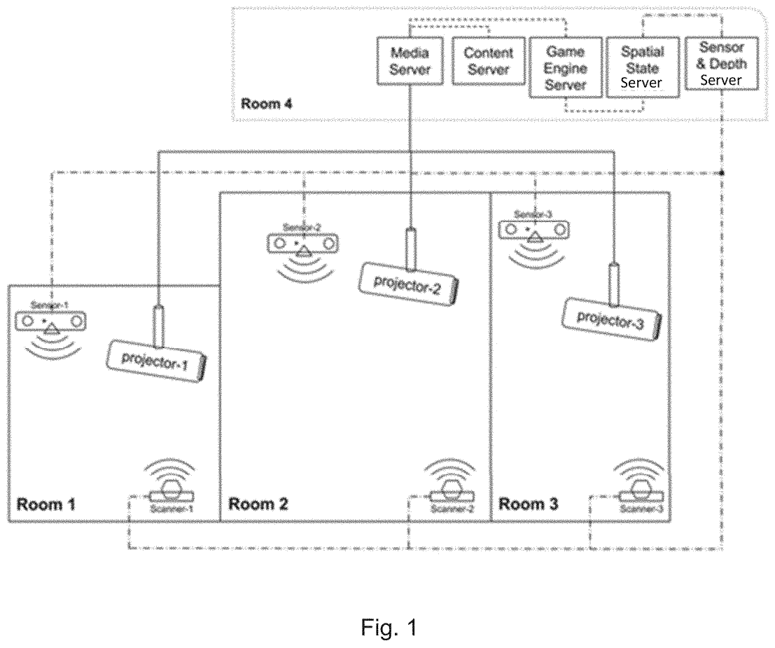

Referring now to the drawings, FIG. 1 illustrates connectivity and data flow for a multiple-room system. Multiple sensors are preferably disposed within each room to track positional data of individuals in 3-dimensional space—for example, along XYZ axes, within the physical space and virtual 3D environment, as well as the position and movement of body extremities such as hands and feet relative to the individual. The positional data can also include non-human input and devices.

A spatial state server for sensor and depth data is preferably provided and is configured to aggregate and normalize sensor data both within a single room or zone, and within a larger system—for example, one having multiple rooms, zones and sub-rooms. The sensors can include time-of-flight, LIDAR or another range imaging and/or remote sensing sensor or emerging sensor technology that captures depth data in the sensors' field of view, allowing people and objects to be tracked in 3D space. The number of sensors is variable and driven by the desired coverage area, and also by the need or desire to eliminate depth shadows. Depth shadows are created when a person or object is captured by a single sensor, but another object or person behind the original person or object cannot be detected. Placing a second sensor, for example, so that sensors are at both sides of a person eliminates this depth shadow, allowing a more accurate depth image and tracking. Sensors are preferably connected to a small personal computer—most preferably using a web socket server to send the data over a wired Ethernet network, which data preferably passed to a spatial state server, which can be the sensor and depth server, and which is preferably configured to process, triangulate and track the coordinates of an individual's position within the larger system without requiring the use of headsets, handsets or other hardware on the individual's person. This data is then preferably mapped within the media distribution system to align in a one-to-one fashion with the individual or individuals using the system. A digital representation and positional data of the person or object is preferably made available by this, so when a person in the physical world waves their arms for example, it is possible to map this to the digital presentation content, so that the digital representation of the person is also waving their arms on any wall or floor surface surrounding them. This allows for precise calibration of interaction on any surface.

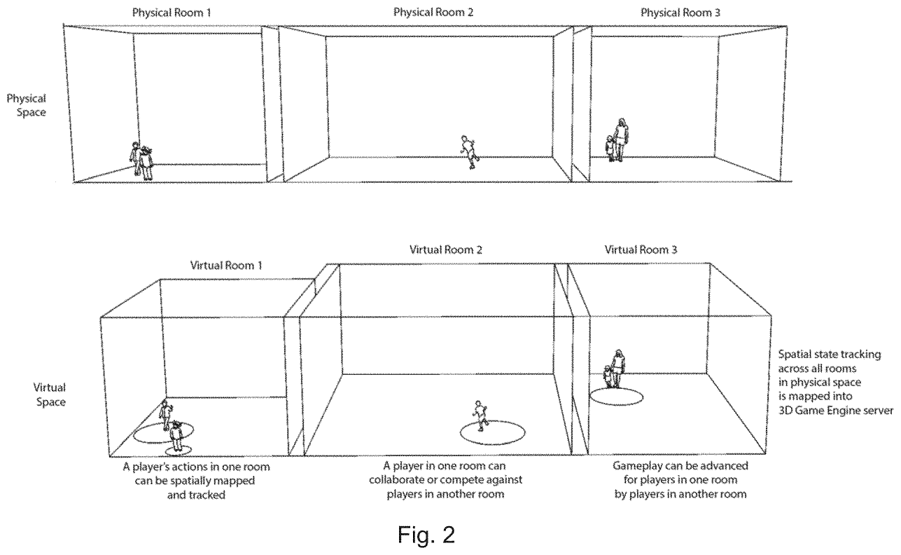

The spatial state server preferably passes data regarding an individual's position in the 3D space and mapped depth image to a game engine server, which can be the media server and which is preferably configured to integrate the data into the overall 3D gaming/experience environment. The game engine server preferably receives the data regarding an individual's position, gestures, and actions, and translates this into a real-time digital (screen-based) representation of the individual within the physical gaming/experience environment, as illustrated in FIG. 2.

Finally, a content server preferably provides flexibility for the addition and compositing of additional content layers, and a media server provides video content distribution to projectors within the physical space. The media server also preferably provides projection-mapping, blending, color corrections and other complex tools to align and configure all media to match the site specifically. Although the application describes various servers, it is to be understood that such various servers can be software servers which can all operate on a single hardware device or which can operate on two or more separate hardware devices.

In one embodiment, the sensor and depth server preferably runs a data depth mapping process to create the aforementioned one-to-one interactive experience with the visitor. JavaScript code, the pseudocode for which is listed below, is preferably used to define the mufti-stage process of taking 3D depth data from a sensor/camera and mapping depth data of a person—for example, to be relative to a designated surface such as a wall in a space, instead of their position being relative to the sensor/camera's position. This process preferably includes acquiring individual sensor 3D depth data and sensor properties, defining a mathematical 2D plane region that corresponds to a plane in physical space such as a floor or a wall, re-projecting the 3D data onto the 2D plane, scaling and transforming the 2D plane data to accurately represent an individual's position in the physical space relative to the 2D plane, and then overlaying and aligning multiple 2D planes of data from multiple sensors to allow for the triangulation of position and depth based on multiple sensors.

A mapping process preferably includes defining the acquisition of an individual sensor and any relevant parameters such as camera field of view and resolution, which is preferably used for calculations later in the process. This preferably presents depth data native to the sensor/camera.

Next, while viewing 3D depth data output from the sensor/camera, a flat 2D surface/plane, preferably referenced as the plane of best fit, is selected in the software using a quad sampling tool that also defines the X and Z axes to be used later in calculations. A larger sampling area is best because more data points can be sampled. This 2D plane typically references and corresponds to the plane of a floor or a wall in the physical space but can optionally correspond to some other surface.

All 3D depth data is preferably flattened onto the 2D plane using a plane of best fit calculation, which re-projects all data relative to the 2D plane instead of being relative to the perspective of the sensor/camera. This provides an individual's distance from the 2D plane and their XZ position.

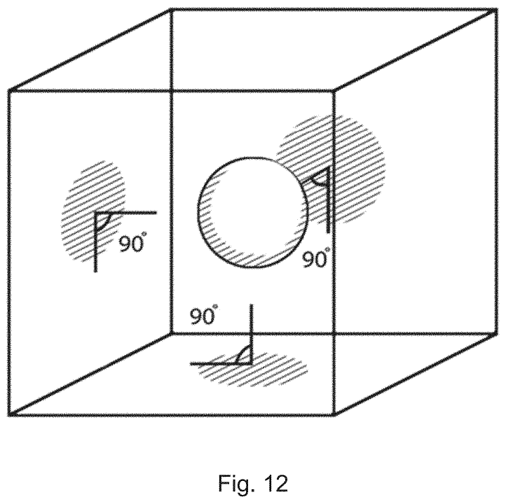

Then, an iterative process of scaling and transforming the 2D plane data while referencing a person moving about in the physical space calibrates the overall re-projected data and the person's position for accuracy. The person's position is most preferably always at 90 degrees to its projected image on a 2D plane because the depth data is preferably flattened (see FIG. 12).

Finally, multiple 2D planes are preferably overlaid onto each other, most preferably such that each are from a different sensor/camera. An additional iterative process is preferably used to scale and transform the multiple planes relative to each other to triangulate position and maintain tracking and position continuity as a person moves from the field of view of one sensor to another sensor. An example of pseudocode which accomplishes this 1:1 mapping includes:
1. [Receive infrared or RGB camera image]
2. [Analyze infrared or RGB image]
   look for recognizable IR patterns
   look for recognizable colors/color patterns
   look for recognizable sequences of IR/color light flashes
3. [Assign unique identifier to each recognized pattern]
4. [Search connected objects (NFC, RFID, WiFi) for existing connections]
5. [Using identified information, apply mapping algorithm]
   apply mathematical matrix of camera to IR or color pattern location
   apply existing mapping settings to result (from previously described mapping process)
6. [Present user with context and DEVICE-aware media and content]
1. [Receive depth data from sensor] [byte array]
2. [Analyze depth data]
   loop through depth data
   analyze depth data for planes
   calculate primary plane locations
3. [User input to choose planes of interaction from depth data]
   user picks top edge of interaction plane on depth image
   user picks side edge of interaction plane on depth image
   user drags corners of selection plane to best fit plane on depth plane
4. [System analyzes depth of selected plane]
5. [System created a 3D matrix based on the depth and orientation of the plane]
6. [System applies a mathematic transform to the depth image based on the selected plane of interaction]
7. [The updated and mapped depth image is presented to the user]
8. [User adjusts the depth image for consistency in height and location]
   user uses simple controls to move image up and down
   user uses simple controls to move image left and right
9. [Final mapped depth is now 1:1 on the interaction plane]
10. [Process repeated for each physical interaction surface]

Based on the calculations done in the mapping process outlined in the foregoing pseudocode, a set of XYZ coordinates is provided by the spatial state server for each user or object. As these objects move and locations are recalculated, their locations are compared to those of other entities and users for differentiation. Using details of location, which can include for example down to millimeter precision or based on particular sensor granularity, for each object, their position can be tracked throughout the building and between multiple surfaces, rooms and sensors.

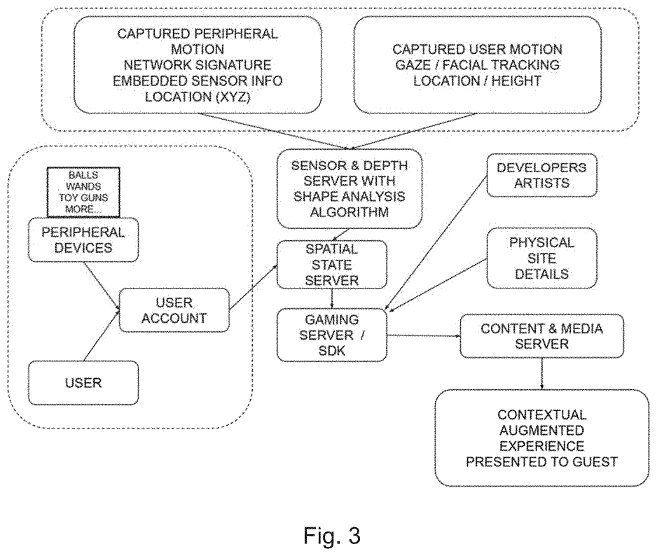

FIG. 3 is a system outline of a process for re-projecting the depth and motion data from a general sensor array to a one-to-one user experience, which illustrates the flexibility of inputs of an embodiment of the present invention.

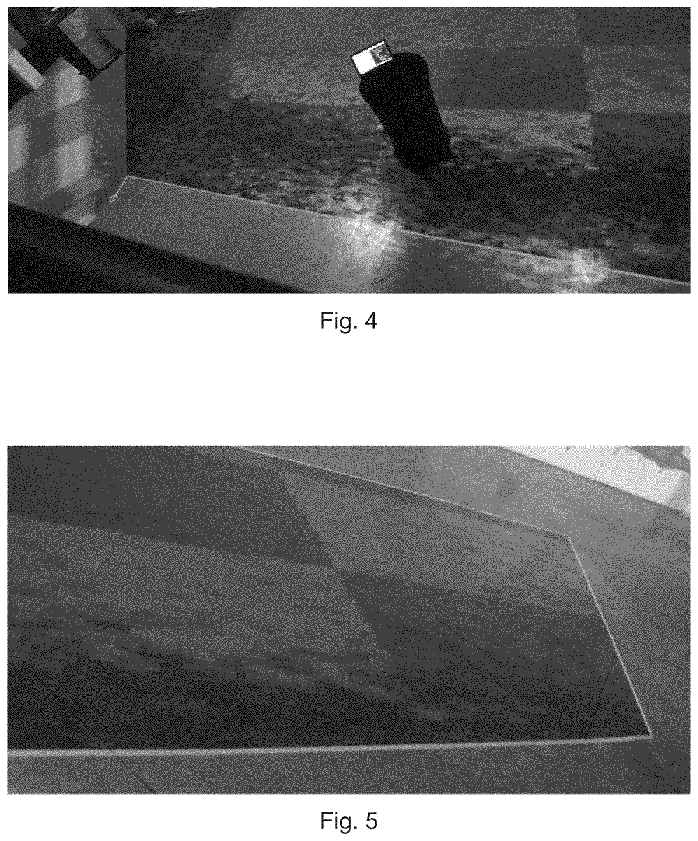

In one embodiment, an initial calibration mode is preferably used to find the plane of best fit. In this embodiment, the bold black line to the left of the figure can be the most important axis in the process to align along an edge that corresponds to an edge in the physical space. In one embodiment, as best illustrated in FIG. 4, the edge is preferably the intersection of a wall and a floor, the red line is preferably moved to the left to be parallel and at the edge of the banding in the lower left corner of the image.

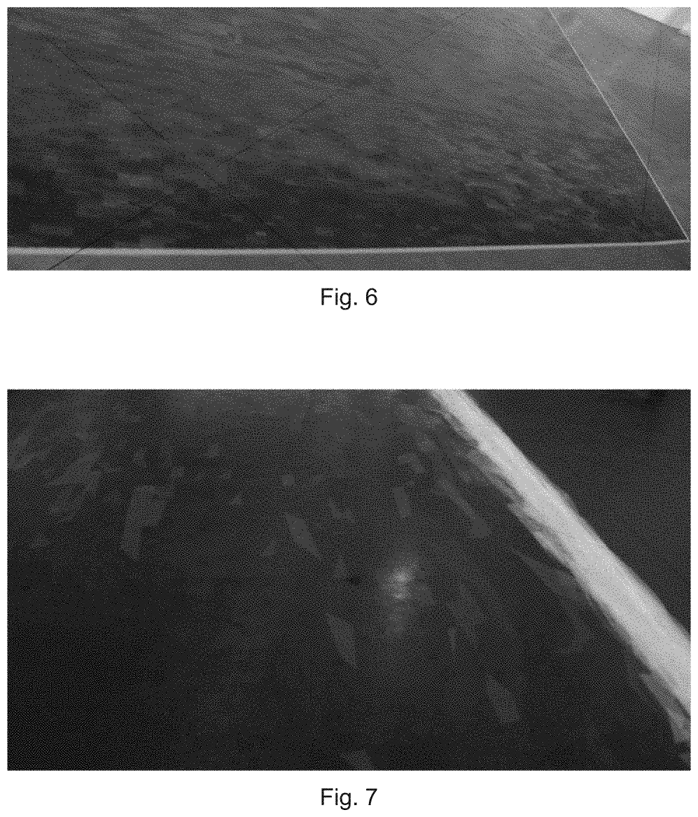

To find the plane of best fit, in one embodiment, the checkerboard pattern in the center and upper right portion of the figure is preferably used and a color progression is assigned to identify depth values. FIG. 5 illustrates a non-noisy checkerboard plane that is a first color, indicating that it is still some distance from the plane of best fit. As the plane is transformed closer to the actual physical planar surface of the floor, the color can change to a second color, which can arbitrarily be assigned to zero, and the checkerboard can become noisy as it approaches and detects the actual physical surface, which introduces noise to the mathematical plane (see FIG. 6). The noise in this context is simply the physical floor being detected, and allows the alignment of the mathematical plane to the physical floor.

The data is then cleaner and more accurate to the surface as illustrated in FIG. 7. It is helpful to scale and transform the data to match the exact physical size, scale and location of the media.

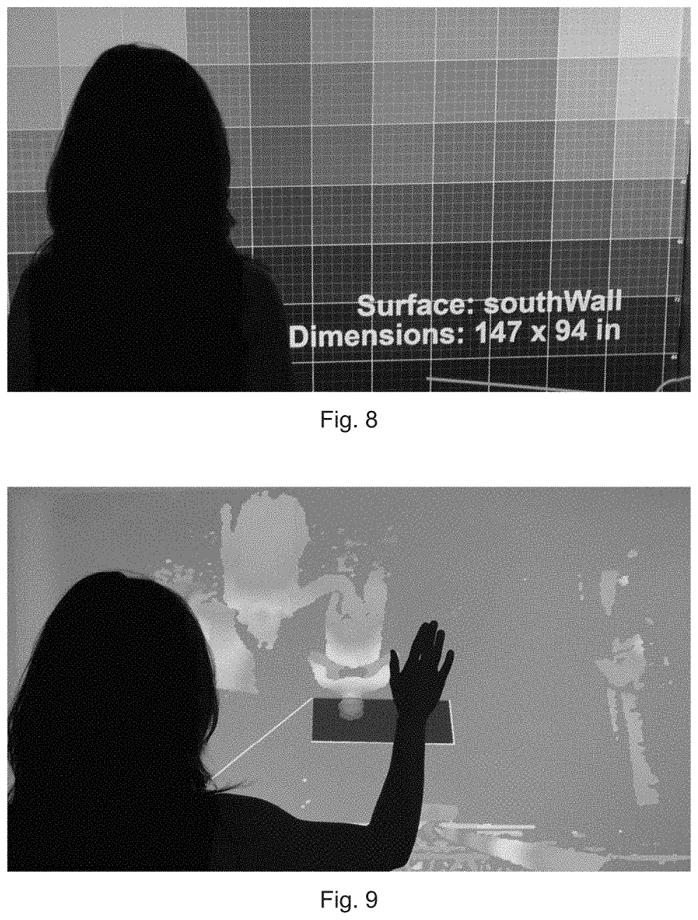

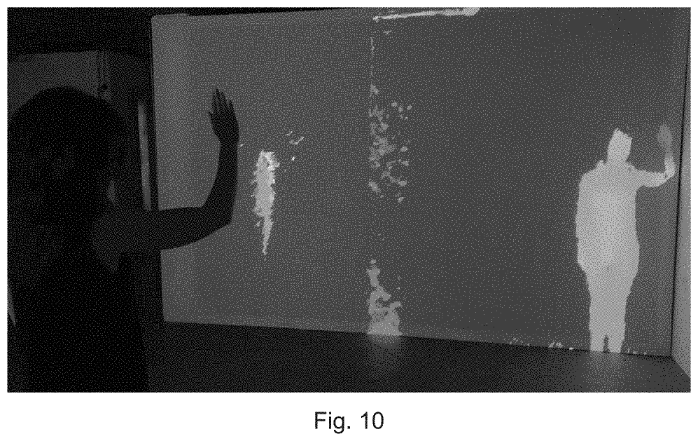

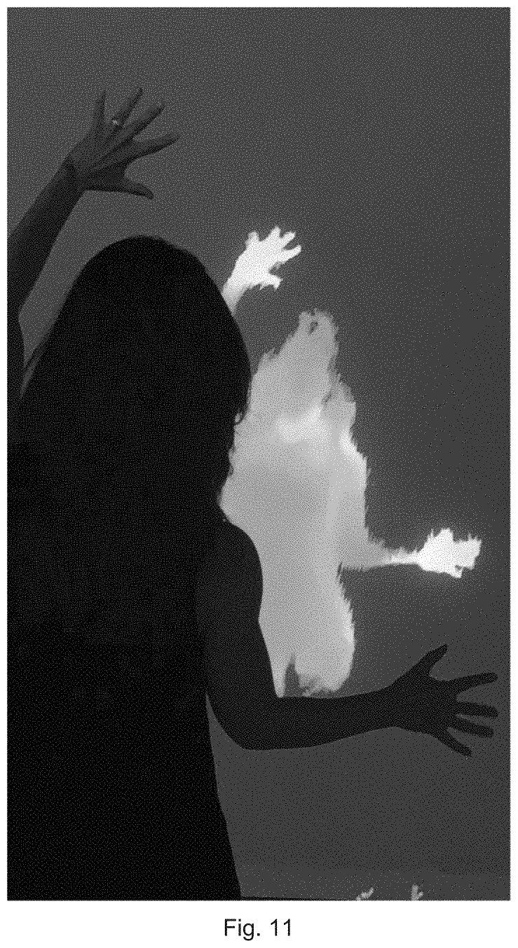

In one embodiment, a final step in the process preferably includes scaling, translating and skewing the plane of data to match the physical space using a traditional corner-based quad calibration—most preferably with keyboard controls for finer calibration. This allows the alignment of the plane of data perfectly with the plane of media content and, most importantly, with the visitor (see FIGS. 8-11). FIG. 8 illustrates the project plane of media at exact scale; FIG. 9 illustrates the initial skewed, inverted and full depth image before mapping and alignment; FIG. 10 illustrates the re-projected plane, before alignment; and FIG. 11 illustrates the re-projected and aligned plane of interaction—one-to-one with user location.

The spatial state server and the overall spatial gaming software development kit (“SDK”) also preferably account for, but are not limited to, the integration of particular peripheral devices that a visitor can optionally use to enhance their experience as further described below.

For ball interactions, the spatial state server preferably comprises a ball tracking algorithm that accounts for circular objects. As best illustrated in FIG. 12, using the similar depth re-mapping process for analyzing body motion, the ball tracking algorithm preferably analyzes the depth image based on each axis (X, Y, Z) and uses standard computer vision methods for ascertaining the circular shape (within a defined size range) within each plane (XY, YZ, ZX). If all three planes equally return the appropriate size and shape of the expected range of circular elements, a ball is recognized. This tracking system allows for specialized tracking and treatment of ball and ball-like objects for a variety of active ball games. Specialized balls can be provided that contain one or more sensors and which can send and receive data, thus allowing them to engage in unique ways with the system through additional network protocols, which can include but are not limited to Bluetooth, WiFi, near-field communication (“NFC”), radio-frequency identification (“RFID”) technologies, combinations thereof and the like, to provide a further layer of engagement.

For pens, wands, flashlights and other ‘wand-like’ objects, the spatial state server preferably has a tracking algorithm that accounts for infrared and marker-enabled wand-like devices within the space. This tracking system preferably allows for specialized tracking and treatment of wand-like objects for greater variety of active game integration. This additional integration allows for mechanisms such as drawing, painting, pointing, throwing, fishing, swinging and other specific interactions that a wand-like object provides. Specialized wands can be provided that contain one or more sensors and which can send and receive data, with the system through additional network protocols, which can include but are not limited to Bluetooth, WiFi, NFC, RFID, combinations thereof and the like, to provide a further layer of engagement and personalization. This can optionally include storing scores and game data for future evaluation and expanded gameplay.

In one embodiment, guns, gloves, hats, other wearables and/or gear can optionally be provided. In this embodiment, the spatial state server has a built-in tracking algorithm that accounts for infrared and marker-enabled guns and/or other usable and/or wearable devices within the space. This tracking system preferably allows for specialized tracking and treatment of these objects for a greater variety of active game integration. This additional integration preferably allows for mechanisms such as shooting of all varieties and touching. Tracking of unique wearables or clothing preferably allows for augmented layers to be provided through the media system at the location of the user. This can take the shape of, but is not limited to, a special hat, causing the user to be represented with a hat on in all digital worlds or a marker on a shirt creating a cape on the visitor's digital counterpart on the media surface. Specialized guns and wearables that can contain one or more sensors and network connectivity allow them to engage in unique ways with the system through additional network protocols (Bluetooth, WiFi, NFC, RFID, combinations thereof and the like) to provide a further layer of engagement and personalization—including storing scores and game data for future evaluation and expanded gameplay.

While certain peripheral components have been described above, embodiments of the present are not limited in interaction capability by these implementations of peripheral tracking. Any object that has a unique shape, infrared signature, and/or embedded sensor technology preferably has the ability to interact directly with the spatial state server and the immersive gaming SDK.

While gaming is discussed primarily in the examples stated herein, embodiments of the platform have applications far beyond gaming. The spatial state server and immersive spatial SDK can be applied to education, training, healthcare, teambuilding, and stage/music production. More specifically, the spatial state server and immersive spatial SDK can be applied in any field where the user's physical motion and direct input then influence a media context to change to fit the situation. The system is built for rapid deployment and changing of content and can be applied to numerous (if not unlimited) external markets that may require an immersive experience.

Embodiments of the present invention provide a technology-based solution that overcomes existing problems with the current state of the art in a technical way to satisfy an existing problem for providing interactive gaming on a large scale. An embodiment of the present invention is necessarily rooted in computer technology in order to overcome a problem specifically arising in the realm of computers. Embodiments of the present invention achieve important benefits over the current state of the art, such as the ability to provide a large-scale interactive immersive gaming experience for users who are not necessarily in the same room, without requiring the users to continuously wear or hold headsets or handsets.

Embodiments of the present invention preferably include a system of media distribution and sensor-based interaction which improves on a variety of existing systems in multiple ways. For traditional media-based systems, while sensors and screens have been combined for years, the building-scale tracking and re-distribution of media and content based on the feedback from that tracking is unique. Virtual Reality systems have begun to explore large-scale collaborative play, but these experiences require large wearable computing devices and ‘virtualize’ the other players, thus creating a less personal experience. Embodiments of the present invention overcome those limitations by tracking individual users, optionally through multiple spaces, with the ability to uniquely identify a person through their interactions—thus not only making the experience interactive, but also personal, and thereby providing the ability to track scores and usage for future visits and gameplay. The uniqueness of the 1-to-1 scaled depth data that tracks user motion gives each user an individual height-appropriate and context aware experience that differentiates from other existing experiences. A 36″ inch tall 4-year-old has an experience that connects to them at their height, where a 72″ adult has an experience that connects to them at their appropriate height.

Embodiments of the present invention are preferably multilayered and continuous, allowing for multiple gaming frameworks and content creation systems to run separately and send their output through the system. Each software framework preferably has access to the sensor data that has been abstracted from the sensors in a way that makes it universal for a game or media creator, thus providing the ability to change from one game to another with a seamless transition, while constantly keeping interaction with the guest such that there is no user-perceivable pause in content distribution or interaction.

Embodiments of the present invention can extend and co-exist outside of building bounds, allowing for continued gameplay and input through the use of mobile and personal computing devices. Using standard network protocols, sensors based within the building and the sensor arrays provided by modern smartphone devices, the invention can continue to supply gameplay outside of the context of the physical location. This allows for more personalized input and even greater individualized context-aware media distribution. A first user can play a game through their phone from a remote location which in turn directly affects and updates the game that a second user is playing at a different location.

The preceding examples can be repeated with similar success by substituting the generically or specifically described components and/or operating conditions of embodiments of the present invention for those used in the preceding examples.

Optionally, embodiments of the present invention can include a general or specific purpose computer or distributed system programmed with computer software implementing steps described above, which computer software may be in any appropriate computer language, including but not limited to C++, FORTRAN, BASIC, Java, Python, JavaScript, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

Note that in the specification and claims, “about” or“approximately” means within twenty percent (20%) of the numerical amount cited. All computer software disclosed herein may be embodied on any non-transitory computer-readable medium (including combinations of mediums), including without limitation CD-ROMs, DVD-ROMs, hard drives (local or network storage device), USB keys, other removable drives, ROM, and firmware.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

What is claimed is:

1. A real-time spatial positioning system comprising:
one or more sensors;
one or more projectors;
a sensor and depth server configured to acquire data from said one or more sensors;
a spatial state server configured to triangulate a position of a physical object within a three-dimensional (“3D”) physical space;
a game engine server configured to communicate with said spatial state server such that movement of the object causes effects on digital, non-physical objects or environments; and
a media server configured to distribute content to said one or more projectors in the physical space, wherein the content comprises a mapped projected representation of the object within the 3D physical space and wherein the content is viewable by a user without requiring the user to wear a headset.

2. The real-time spatial positioning system of claim 1 wherein the content is viewable by a user without requiring the user to wear or hold a handset.

3. The real-time spatial positioning system of claim 1 wherein said one or more sensors comprise one or more motion sensors.

4. The real-time spatial positioning system of claim 1 wherein said one or more sensors comprise one or more depth sensors.

5. The real-time spatial positioning system of claim 1 wherein said one or more sensors comprise one or more radio-frequency identification sensors.

6. The real-time spatial positioning system of claim 1 wherein said 3D physical space comprises a plurality of physically separate 3D physical spaces.

7. The real-time spatial positioning system of claim 6 wherein said plurality of physically separate 3D physical spaces comprise a plurality of rooms.

8. The real-time spatial positioning system of claim 1 wherein said sensor and depth server is configured to aggregate a plurality of sensors across a plurality of physically separate 3D physical spaces.

9. The real-time spatial positioning system of claim 1 wherein the content comprises a 1:1 mapped projected representation of the object.

10. The real-time spatial positioning system of claim 9 wherein the projected representation is projected onto a physical surface within the 3D physical space.

11. The real-time spatial positioning system of claim 1 wherein the physical object comprises a person.

12. The real-time spatial positioning system of claim 11 wherein said spatial state server is configured to track gestures of the person.

13. The real-time spatial positioning system of claim 1 wherein at least some content is projected onto at least half of all surfaces in the 3D physical space.

14. The real-time spatial positioning system of claim 1 wherein the physical object comprises a plurality of physical objects and wherein at least one of the plurality of physical objects comprises a person and wherein another of the plurality of physical objects comprises an inanimate physical object.

15. The real-time spatial positioning system of claim 14 wherein the inanimate physical object comprises a ball or a wand.

16. The real-time spatial positioning system of claim 1 wherein a single hardware device operates at least two of said sensor and depth server, said spatial state server, and said media server.

17. The real-time spatial positioning system of claim 1 wherein said real-time spatial positioning system is configured to perform a calibration routine whereby a plane of best fit is determined for at least one surface in the 3D physical space.

18. A method for providing a spatial positioning system comprising:
sensing a three-dimensional (“3D”) location of an animal within an environment comprising at least a pair of walls and a floor;
generating data representative of effects caused to non-physical objects based on movement of the animal; and
projecting an image that is representative of the generated data onto at least the pair of walls in real time or near-real time.

19. The method of claim 18 wherein the animal is a human.

20. The method of claim 18 wherein the projecting an image comprises projecting an image that includes a representation of the animal at a size ratio of at least about 1:1.
